(19) United States
(12) Patent Application Publication
(10) Pub. No.: US 2009/0038906 A1
(43) Pub. Date: Feb. 12, 2009

(54) SEAL INTEGRAL TYPE PISTON

(75) Inventors: Tomoaki Nishimura, Fukushima (JP); Koji Fujii, Fukushima (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/187,711

(22) Filed: Aug. 7, 2008

(30) Foreign Application Priority Data
Aug. 10, 2007 (JP) 2007-209354

(51) Int. Cl. F16D 25/06

(52) U.S. Cl. 192/85 AA

(57) ABSTRACT

To maximize pressing area of a clutch pressing portion (121f) in a seal integral type piston (120) having a piston main body (121) and a seal lip (122), a conical step surface (121g) is formed on an outer surface of an outer peripheral cylinder portion (121e), a clutch pressing portion (121f) is provided at an end of the outer peripheral cylinder portion (121e) via the conical step surface (121g), an end of a rubber film (124) extending from a base portion of the seal lip (122) along the outer surface of the outer peripheral cylinder portion (121e) is positioned at the conical step surface (121g), and a large radial width (a pressing area) of the clutch pressing portion (121f) is secured by making a rubber stop at a time of integrally molding the seal lip (122) on the piston main body (121) at the conical step surface (121g).

### BACKGROUND OF THE INVENTION

1. Field of the Invention

This invention relates to a seal integral type piston used in a hydraulically actuated clutch of an automatic transmission of a vehicle.

2. Description of the Conventional Art

A hydraulically actuated clutch in an automatic transmission of a vehicle is structured such that a clutch piston moving in an axial direction within a clutch cylinder by hydraulic pressure brings drive plates at a drive shaft side in a multiple disc clutch into contact with driven plates at a driven shaft side, and a seal integral type piston (also called as a bonded piston seal or a seal bonded piston) is known as the clutch piston. The seal integral type piston is structured such that seal lips are integrated with an outer peripheral portion and an inner peripheral portion of a piston main body in accordance with vulcanization bonding.

FIG. 5 is a half sectional view showing an outline structure of a hydraulically actuated clutch using a conventional seal integral type piston by cutting it along a plane passing through an axis O, and FIG. 6 is a sectional view in which a part of FIG. 5 is enlarged. In a hydraulically actuated clutch shown in FIG. 5, reference numeral 1 denotes an annular clutch cylinder turning together with a drive shaft (not shown), reference numeral 2 denotes a seal integral type piston arranged within the clutch cylinder 1 so as to be movable in an axial direction, and defining a hydraulic chamber 4 between the piston and an end plate portion 1a of the clutch cylinder 1, and reference numeral 3 denotes a multiple disc clutch in which a plurality of drive plates 31 and a plurality of driven plates 32 are arranged alternately in an axial direction, the drive plates 31 are locked to the clutch cylinder 1 in a circumferential direction in a state of being movable in the axial direction, and the driven plates 32 are locked to a clutch hub 33 provided at the driven shaft (not shown) side in the circumferential direction in a state of being movable in the axial direction. An oil passage 1d for introducing hydraulic pressure generated by oil (ATF) to the hydraulic chamber 4 is provided in an inner cylinder portion 1c of the clutch cylinder 1.

The seal integral type piston 2 integrally has a piston main body 21 constituted by a metal press formed product, and seal lips 22 and 23 integrally formed in inner and outer peripheries of the piston main body 21, slidably brought into close contact with an outer cylinder portion 1b and the inner cylinder portion 1c of the clutch cylinder 1 and made of a rubber-like elastic material, and is pressed in a direction reducing a volume of the hydraulic chamber 4, in other words, a direction moving away from the multiple disc clutch 3, by a return spring (not shown). An outer peripheral cylinder portion 21a of the piston main body 21 has a clutch pressing portion 21b in its leading end, and is opposed to the multiple disc clutch 3 in the axial direction.

In particular, since the seal integral type piston 2 is displaced in the axial direction within the clutch cylinder 1 against the pressing force of the return spring (not shown) by applying of the hydraulic pressure to the hydraulic chamber 4 via the oil passage 1d, and presses the drive plates 31 to the driven plates 32 in the multiple disc clutch 3, the hydraulically actuated clutch comes to a connected state transmitting power from the drive shaft to the driven shaft.

Next, when the hydraulic pressure in the hydraulic chamber 4 is released, the seal integral type piston 2 is displaced in the axial direction within the clutch cylinder 1 toward a direction reducing the volume of the hydraulic chamber 4 on the basis of the pressing force of the return spring, and releases the pressure contact between the drive plates 31 and the driven plates 32 in the multiple disc clutch 3. Accordingly, the seal integral type piston 2 shuts off power transmission from the drive shaft to the driven shaft (for example, refer to Japanese Unexamined Patent Publication No. 2001-241467).

In the seal integral type piston 2 of this kind of hydraulically actuated clutch, since it is hard to stop a flow of a molding rubber material at an outer peripheral surface of the outer peripheral cylinder portion 21a of the piston main body 21 at a time of integrally molding the seal lip 22 at an outer peripheral side, a rubber film 22a is formed to extend from the seal lip 22 at the outer peripheral side so as to cover an outer peripheral surface of the outer peripheral cylinder portion 21a of the piston main body 21. Then, if a leading end of the rubber film 22a comes around the clutch pressing portion 21b, there occurs contamination caused by peeling of the rubber at the clutch pressing portion 21b at a time of coming into contact with the multiple disc clutch 3. Therefore, in accordance with a conventional art, as shown in FIG. 6, an annular step portion 21c forming a plane approximately orthogonal to an axis is provided recessively at an outer peripheral side of the clutch pressing portion 21b, and a rubber stop at a time of molding is carried out at the annular step portion 21c.

In this case, in order to press a metal mold to the annular step portion 21c so as to securely shut off the wraparound of the rubber, it is necessary to form a radial width w₁ of the annular step portion 21c equal to or more than a predetermined size. Accordingly, a width (a pressing area) w₂ of the clutch pressing portion 21b becomes narrow, surface pressure of the clutch pressing portion 21b at a time of pressing the multiple disc clutch 3 becomes large, and an abrasion tends to progress. Further, a distance to the multiple disc clutch 3 is changed thereby, and there is a risk that a bad influence is given to a function of a transmission.

### SUMMARY OF THE INVENTION

### Problem to be Solved by the Invention

The present invention is made by taking the points mentioned above into consideration, and a technical object of the present invention is to secure a maximum pressing area of a clutch pressing portion in a seal integral type piston used in a hydraulically actuated clutch.

### Means for Solving the Problem

As a means for effectively solving the technical problem mentioned above, in accordance with a first aspect of the present invention, there is provided a seal integral type piston having a piston main body arranged within a clutch cylinder so as to be movable in an axial direction; and a seal lip integrally provided on an outer peripheral cylinder portion of the piston main body and slidably brought into close contact with an inner surface of the clutch cylinder so as to be slidable in the axial direction, wherein a conical step surface reduced in its diameter toward a leading end side is formed on an outer peripheral surface of the outer peripheral cylinder portion of the piston main body, a clutch pressing portion capable of pressing a multiple disc clutch is provided so as to protrude at a leading end of the outer peripheral cylinder portion of the piston main body via the conical step surface, and an end portion of a rubber film extending from a base portion of the seal lip so as to cover the outer peripheral surface of the outer peripheral cylinder portion of the piston main body is positioned at the conical step surface or an end portion of the conical step surface. In other words, a large radial width of the clutch pressing portion is secured in a radial width of the outer peripheral cylinder portion of the piston main body, by carrying out a rubber stop at a time of integrally molding the seal lip on the outer peripheral cylinder portion of the piston main body at the conical step surface.

Further, as another solution, in accordance with a second aspect of the present invention, there is provided a seal integral type piston having a piston main body arranged within a clutch cylinder so as to be movable in an axial direction; and a seal lip integrally provided on an outer peripheral cylinder portion of the piston main body and slidably brought into close contact with an inner surface of the clutch cylinder so as to be slidable in the axial direction, wherein a clutch pressing portion capable of pressing a multiple disc clutch is provided at a leading end of the outer peripheral cylinder portion of the piston main body, the clutch pressing portion is made by bending a leading end portion of the outer peripheral cylinder portion of the piston main body into a conical tubular shape which expands to an outward radial side and forming a surface opposed to the multiple disc clutch in a plane shape approximately vertical to an axis, and an end portion of a rubber film extending from a base portion of the seal lip so as to cover the outer peripheral surface of the outer peripheral cylinder portion of the piston main body is positioned at a conical outer peripheral surface of the clutch pressing portion. In other words, a radial width of the clutch pressing portion is made larger than a radial width of the outer peripheral cylinder portion by forming the leading end portion of the outer peripheral cylinder portion bent in the conical tubular shape to be in a plane shape approximately vertical to the axis, so that a rubber stop at a time of integrally molding the seal lip on the outer peripheral cylinder portion of the piston main body can be carried out at the conical outer peripheral surface of the clutch pressing portion.

### Effect of the Invention

In accordance with the seal integral type piston on the basis of the first or second aspect of the present invention, it is possible to secure the clutch pressing portion having the sufficiently large radial width, by carrying out a rubber stop at a time of integrally molding the seal lip at the conical step surface or the conical outer peripheral surface formed on the outer peripheral cylinder portion of the piston main body. As the result thereof, it is possible to suppress abrasion by reducing surface pressure of the clutch pressing portion at a time of pressing the multiple disc clutch, and thus it is possible to prevent an adverse effect given to a transmission.

### BRIEF EXPLANATION OF DRAWINGS

FIG. 1 is a half sectional view showing a first embodiment of a seal integral type piston in accordance with the present invention by cutting it along a plane passing through an axis O together with a part of a hydraulically actuated clutch;

FIG. 2 is an enlarged sectional view of a substantial part of FIG. 1;

FIGS. 3(A) and 3(B) are enlarged sectional views of a substantial part showing shape modified examples in the first embodiment;

FIG. 4 is a partial sectional view showing a second embodiment of the seal integral type piston in accordance with the present invention by cutting it along a plane passing through an axis O;

FIG. 5 is a half sectional view showing an outline structure of a hydraulically actuated clutch using a conventional seal integral type piston by cutting it along a plane passing through an axis O; and

FIG. 6 is a sectional view showing a part in FIG. 5 in an enlarged manner.

### DETAILED DESCRIPTION OF PREFERRED EMBODIMENT

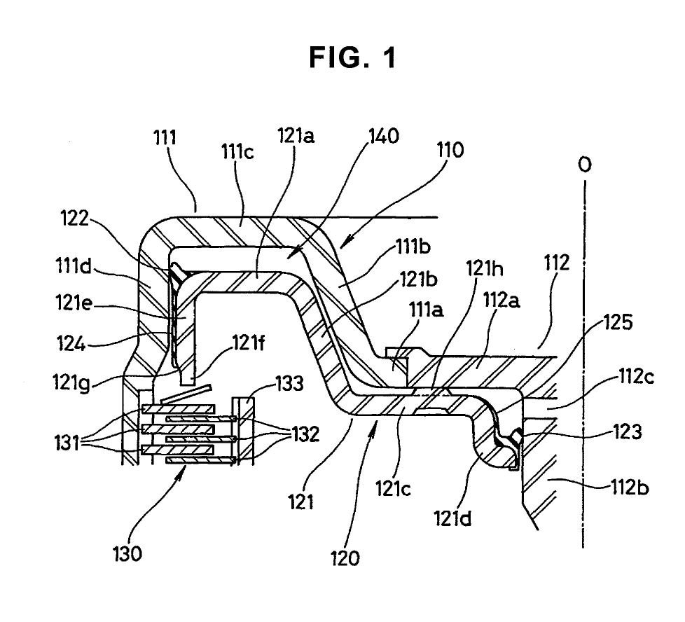

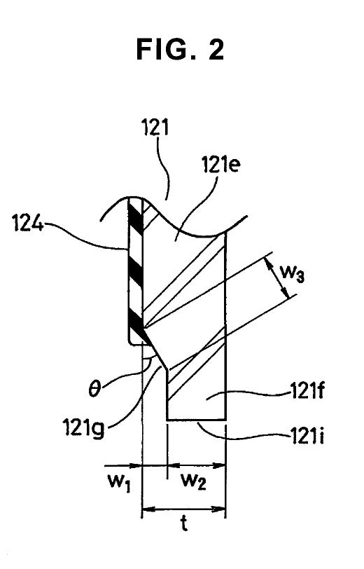

A description will be given below of a preferable embodiment of a seal integral type piston in accordance with the present invention with reference to the accompanying drawings. FIG. 1 is a half sectional view showing a first embodiment of the seal integral type piston in accordance with the present invention by cutting it along a plane passing through an axis O together with a part of a hydraulically actuated clutch, and FIG. 2 is an enlarged sectional view of a substantial part of FIG. 1.

In a hydraulically actuated clutch for an automatic transmission shown in FIG. 1, reference numeral 110 denotes a clutch cylinder turned around the axis O together with a drive shaft (not shown), reference numeral 120 denotes a seal integral type piston in accordance with the present invention, which is arranged within the clutch cylinder 110 so as to be movable in an axial direction, and reference numeral 130 denotes a multiple disc clutch.

The clutch cylinder 110 is a joint body of an outer peripheral member 111 and an inner peripheral member 112. The outer peripheral member 111 is constituted by an inward collar portion 111a, a conical wall portion 111b at an outer peripheral side thereof, a disc portion 111c extended from an outer peripheral end thereof to an outer peripheral side, and an outer cylinder portion 111d formed in such a manner as to be turned back from an outer peripheral end thereof concentrically with the conical wall portion 111b. The inner peripheral member 112 is constituted by an outward collar portion 112a having an outer peripheral edge integrally bonded to the inward collar portion 111a of the outer peripheral member 111 in a state of being tightly fitted, and an inner cylinder portion 112b extending from an inner peripheral end thereof concentrically with the outer cylinder portion 111d of the outer peripheral member 111.

The multiple disc clutch 130 is provided with such a structure that a plurality of drive plates 131 and a plurality of driven plates 132 are alternately arranged in an axial direction, the drive plates 131 are locked to the outer cylinder portion 111d of the clutch cylinder 110 in a circumferential direction in a state of being movable in an axial direction, and the driven plates 132 are locked to a clutch hub 133 provided at a driven shaft (not shown) side in the circumferential direction in a state of being movable in the axial direction.

The seal integral type piston 120 in accordance with the first embodiment of the present invention is provided with a piston main body 121 having an annular shape around the axis O, and seal lips 122 and 123 integrally provided on the piston main body 121.

The piston main body 121 in the seal integral type piston 120 is manufactured by press forming of a metal plate, and is provided with a discoid outer peripheral side pressure receiving portion 121a opposed to the disc portion 111c of the outer peripheral member 111 in the clutch cylinder 110, a conical intermediate pressure receiving portion 121b opposed to the conical wall portion 111b of the outer peripheral member 111, a discoid inner peripheral side pressure receiving portion 121c opposed to the inward collar portion 111a of the outer peripheral member 111 and the outward collar portion 112a of the inner peripheral member 112, an inner peripheral bent end portion 121d formed at an inner peripheral side thereof, an outer peripheral cylinder portion 121e turned back from an outer peripheral end of the outer peripheral side pressure receiving portion 121a and opposed in a radial direction to the outer cylinder portion 111d of the outer peripheral member 111, and a clutch pressing portion 121f provided so as to protrude at a leading end of the outer peripheral cylinder portion 121e via a conical step surface 121g formed on an outer peripheral surface of the outer peripheral cylinder portion 121e so as to have smaller diameter toward a leading end side.

A hydraulic chamber 140 is defined by the seal lips 122 and 123 between a portion from the disc portion 111c of the outer peripheral member 111 in the clutch cylinder 110 to the outward collar portion 112a of the inner peripheral member 112, and a portion from the outer peripheral side pressure receiving portion 121a of the piston main body 121 opposed thereto to the inner peripheral bent end portion 121d, and an oil passage 112c for introducing hydraulic pressure generated by oil (ATF) to the hydraulic chamber 140 is provided in the inner cylinder portion 112b of the inner peripheral member 112 in the clutch cylinder 110.

Further, a plurality of projections 121h punched out to the hydraulic chamber 140 side are formed on the inner peripheral side pressure receiving portion 121c of the piston main body 121 at a uniform interval in a circumferential direction. The projection 121h come into contact with the outward collar portion 112a of the inner peripheral member 112 in the clutch cylinder 110 at a time when the piston main body 121 is moved to a position of its top dead center, thereby preventing the hydraulic chamber 140 from being closed.

The seal lips 122 and 123 in the seal integral type piston 120 are integrally formed on a shoulder portion at an opposite side to the clutch pressing portion 121f of the outer peripheral cylinder portion 121e of the piston main body 121, and an inner peripheral surface of the inner peripheral bent end portion 121d by a rubber-like elastic material. Among them, the seal lip 122 at the outer peripheral side is slidably brought into close contact with the inner peripheral surface of the outer cylinder portion 111d of the clutch cylinder 110, and the seal lip 123 at the inner peripheral side is slidably brought into close contact with the outer peripheral surface of the inner peripheral cylinder portion 112b of the clutch cylinder 110.

A rubber film 124 extending in such a manner as to cover an outer peripheral surface of the outer peripheral cylinder portion 121e of the piston main body 121 is formed from the seal lip 122 at the outer peripheral side. A leading end of the rubber film 124 is positioned at the conical step surface 121g formed on the outer peripheral surface of the outer peripheral cylinder portion 121e.

On the other hand, a rubber film 125 extending in such a manner as to cover an inner peripheral surface of the inner peripheral bend end portion 121d of the piston main body 121 is formed from the seal lip 123 at the inner peripheral side. A leading end of the rubber film 125 extends to a boundary portion between the inner peripheral bent end portion 121d and the inner peripheral side pressure receiving portion 121c while becoming thin little by little.

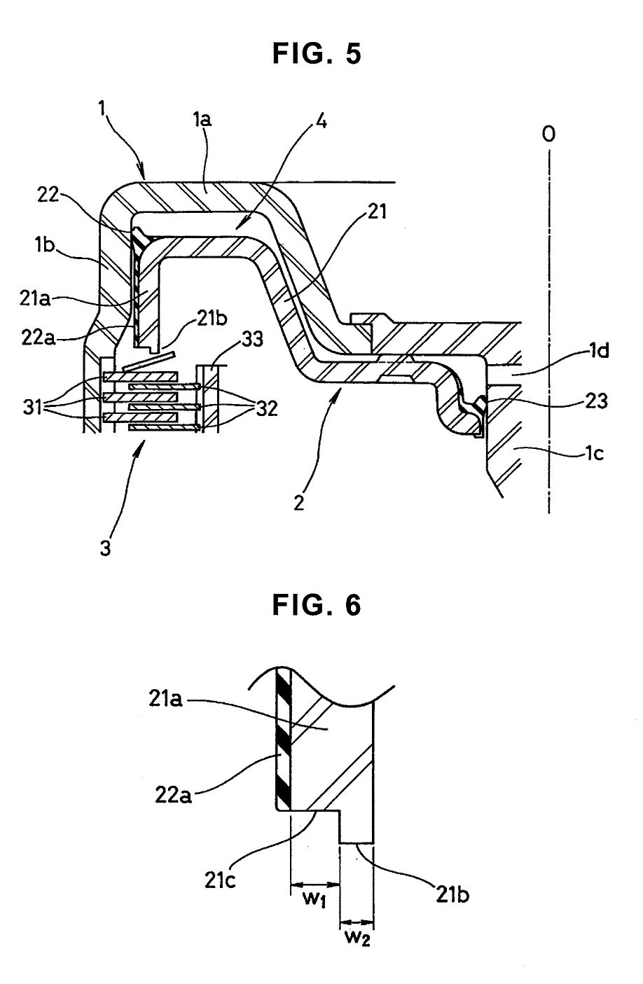

The hydraulically actuated clutch provided with the structure mentioned above applies hydraulic pressure to the hydraulic chamber 140 via the oil passage 112c or releases the hydraulic pressure in the same manner as that in FIG. 5 described previously. Accordingly, the seal integral type piston 120 in accordance with the present invention is displaced in the axial direction within the clutch cylinder 110, thereby actuating the multiple disc clutch 130 so as to be connected or disconnected.

In other words, when the hydraulic chamber 140 is pressurized by feeding of oil (ATF), the seal integral type piston 120 is displaced to a lower side in FIG. 1 while compressing a return spring (not shown), and the clutch pressing portion 121f of the seal integral type piston 120 presses the multiple disc clutch 130, and frictionally engages the drive plates 131 of the multiple disc clutch 130 with the driven plates 132. Accordingly, the multiple disc clutch 130 comes to a connected state, and a drive torque from a drive shaft (not shown) side is transmitted to a driven shaft (not shown) via the clutch cylinder 110, the drive plates 131 and the driven plates 132 of the multiple disc clutch 130 and the clutch hub 133.

Further, when the hydraulic pressure of the hydraulic chamber 140 is released from this connected state, the seal integral type piston 120 is displaced to an upper side in FIG. 1 so as to reduce a volume of the hydraulic chamber 140 on the basis of restoration (elongation) of the compressed return spring, and cancels the pressing to the multiple disc clutch 130. Accordingly, the frictional engagement between the drive plates 131 and the driven plates 132 of the multiple disc clutch 130 is canceled, and the transmission of the drive torque from the drive shaft to the driven shaft is shut off.

In this case, the rubber film 124 extending so as to cover the outer peripheral surface of the outer peripheral cylinder portion 121e of the piston main body 121 is formed by a molding rubber material flowing along the outer peripheral surface of the outer peripheral cylinder portion 121e of the piston main body 121 from a cavity (not shown) to mold the seal lip 122, at a time of integrally forming the seal lip 122 at the outer peripheral side on the piston main body 121. At this time, a rubber stop is achieved to prevent the molding rubber material from going around a pressing surface 121i of the clutch pressing portion 121f, by bringing an inner surface of a metal mold (not shown) into close contact with the conical step surface 121g formed on the outer peripheral cylinder portion 121e of the piston main body 121.

In detail, as shown in FIG. 2, since the conical step surface 121g can secure a sufficient width W₃, the rubber stop can be securely carried out by bringing the metal mold (not shown) into close contact with the conical step surface 121g. Further, when an angle of incline of the conical step surface 121g is denoted by θ, a radial width w₁ of the conical step surface 121g is expressed by w₁=w₃ sin θ, and can be made sufficiently smaller than the width w₃ of the conical step surface 121g. Accordingly, since a thickness of the clutch pressing portion 121f (a radial width w₂ of the pressing surface 121i) does not become so small with respect to a thickness t of the outer peripheral cylinder portion 121e of the piston main body 121. That is, it is possible to secure a comparatively large pressing area with respect to the multiple disc clutch 130, so that surface pressure of the clutch pressing portion 121f is suppressed, and it is possible to suppress progress of abrasion of the pressing surface 121i consequently.

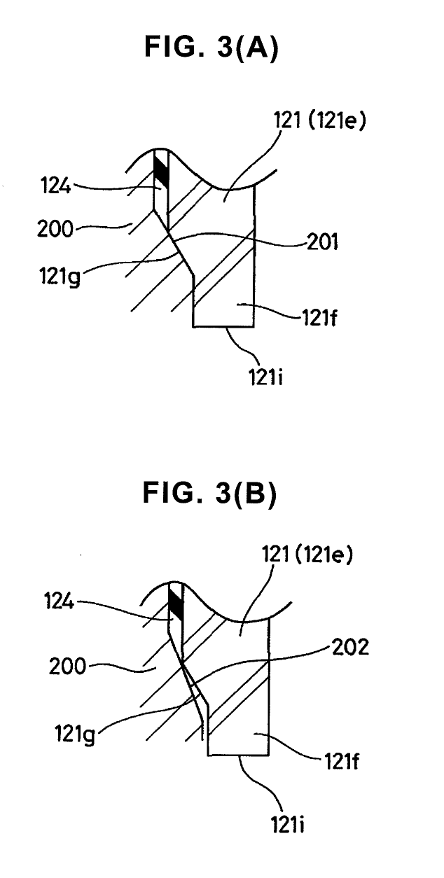

FIGS. 3(A) and 3(B) are enlarged sectionnal views of a substantial part showing shape modified examples in the first embodiment. In other words, the rubber stop of the leading end of the rubber film 124 extending so as to cover the outer peripheral surface of the outer peripheral cylinder portion 121e of the piston main body 121 may be carried out by bringing a conical surface 201 formed in correspondence to the conical step surface 121g of the piston main body 121 in an inner surface of a metal mold 200 into close contact (surface contact) with the conical step surface 121g as shown in FIG. 3(A), or the rubber stop may be carried out by bringing a conical surface 202 formed at a smaller angle of incline than that of the conical step surface 121g of the piston main body 121 in the inner surface of the metal mold 200 into close contact (line contact) with a shoulder portion of the conical step surface 121g of the piston main body 121 as shown in FIG. 3(B).

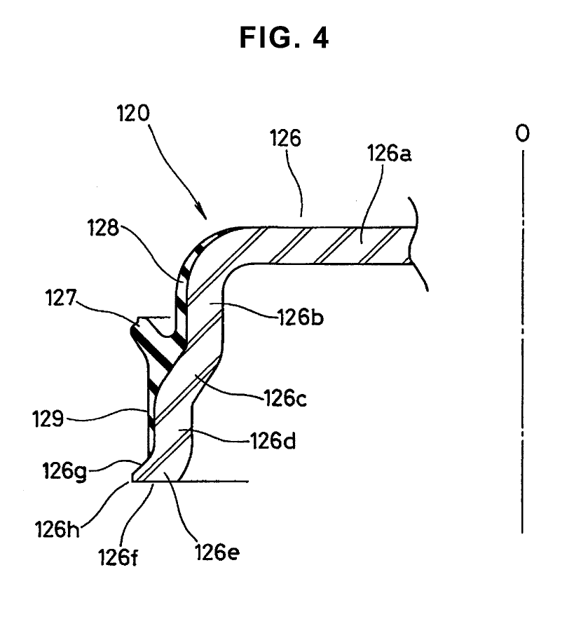

Next, FIG. 4 is a partial sectional view showing a second embodiment of the seal integral type piston in accordance with the present invention by cutting it along a plane passing through the axis O.

In this second embodiment, a piston main body 126 of the seal integral type piston 120 is provided with a discoid pressure receiving portion 126a, a first outer peripheral cylinder portion 126b cylindrically bent from an outer peripheral end thereof, a conical cylinder portion 126c extending from the first outer peripheral cylinder portion 126b so as to expand, a second outer peripheral cylinder portion 126d extending from a large-diameter end portion of the conical cylinder portion 126c, and a clutch pressing portion 126e provided so as to protrude at a leading end thereof. The clutch pressing portion 126e is formed by bending a leading end portion of the second outer peripheral cylinder portion 126d in a conical cylindrical shape which expands to an outward radial side, and working a pressing surface 126f with respect to a multiple disc clutch (not shown) into a plane shape approximately vertical to the axis O. In this case, the second outer peripheral cylinder portion 126d corresponds to the outer peripheral cylinder portion described in the second aspect of the present invention, and the pressing surface 126f corresponds to the surface opposed to the multiple disc clutch described in the second aspect of the present invention.

Further, an outer peripheral side seal lip 127 slidably brought into close contact with the clutch cylinder (not shown) is integrally formed on an outer peripheral surface of the conical cylinder portion 126c of the piston main body 126 by a rubber-like elastic material. Further, an end portion which becomes thin little by little of a rubber film 128 is positioned at a boundary portion between the first outer peripheral cylinder portion 126b and the pressure receiving portion 126a. The rubber film 128 extends from a base portion of the seal lip 127 so as to cover the outer peripheral surface of the first outer peripheral cylinder portion 126b of the piston main body 126. An end portion of a rubber film 129 is positioned at the conical outer peripheral surface 126g of the clutch pressing portion 126e. The rubber film 129 extends from the base portion of the seal lip 127 so as to cover the outer peripheral surface of the second outer peripheral cylinder portion 126d of the piston main body 126.

The seal integral type piston 120 in accordance with the second embodiment having the structure mentioned above operates in the same manner as the first embodiment, and carries out the connection and the disconnection of the multiple disc clutch.

Further, the rubber stop of the rubber film 129 extending so as to cover the outer peripheral surface of the second outer peripheral cylinder portion 126d of the piston main body 126 is carried put by bringing the inner surface of the metal mold (not shown) into close contact with the conical outer peripheral surface 126g of the clutch pressing portion 126e of the piston main body 126 at a time of integrally molding the seal lip 127 at the outer peripheral side on the piston main body 126. Accordingly, since it is possible to secure a sufficient contact width with the inner surface of the metal mold by the conical outer peripheral surface 126g, it is possible to securely carry out the rubber stop in such a manner as to prevent the molding rubber material from going around the pressing surface 126f of the clutch pressing portion 126e.

Further, since the clutch pressing portion 126e is formed by bending the leading end portion of the second outer peripheral cylinder portion 126d into the conical cylinder shape which expands to the outward radial side, and working the pressing surface 126f into the plane shape which is approximately vertical to the axis O, it is possible to make the radial width of the pressing surface 126f larger than the thickness of the second outer peripheral cylinder portion 126d of the piston main body 126. Accordingly, the pressing area of the clutch pressing portion 126e with respect to the multiple disc clutch becomes large, the surface pressure is suppressed, and consequently progress of abrasion can be suppressed.

In this case, in this embodiment, a chamfer or a round chamfer is preferably provided at the outer peripheral edge 126h of the clutch pressing portion 126e in order to avoid a sharp shape.

What is claimed is:

1. A seal integral type piston having:
a piston main body arranged within a clutch cylinder so as to be movable in an axial direction; and
a seal lip integrally provided on an outer peripheral cylinder portion of the piston main body and slidably brought into close contact with an inner surface of said clutch cylinder so as to be slidable in the axial direction,
wherein a conical step surface reduced in its diameter toward a leading end side is formed on an outer peripheral surface of the outer peripheral cylinder portion of said piston main body, a clutch pressing portion capable of pressing a multiple disc clutch is provided so as to protrude at a leading end of the outer peripheral cylinder portion of said piston main body via said conical step surface, and an end portion of a rubber film extending from a base portion of said seal lip so as to cover the outer peripheral surface of the outer peripheral cylinder portion of said piston main body is positioned at said conical step surface or an end portion of the conical step surface.

2. A seal integral type piston having:
a piston main body arranged within a clutch cylinder so as to be movable in an axial direction; and
a seal lip integrally provided on an outer peripheral cylinder portion of the piston main body and slidably brought into close contact with an inner surface of said clutch cylinder so as to be slidable in the axial direction,
wherein a clutch pressing portion capable of pressing a multiple disc clutch is provided at a leading end of the outer peripheral cylinder portion of said piston main body, the clutch pressing portion is made by bending a leading end portion of the outer peripheral cylinder portion of said piston main body into a conical tubular shape which expands to an outward radial side and forming a surface opposed to said multiple disc clutch in a plane shape approximately vertical to an axis, and an end portion of a rubber film extending from a base portion of said seal lip so as to cover the outer peripheral surface of the outer peripheral cylinder portion of said piston main body is positioned at a conical outer peripheral surface of said clutch pressing portion.
